(19) United States
(12) Patent Application Publication
(10) Pub. No.: US 2006/0211425 A1
(43) Pub. Date: Sep. 21, 2006

(54) Method and apparatus for acquiring user equipment capability information in a communication in a communication network

(75) Inventors: Eun-Hui Bae, Seoul (KR); O-Sok Song, Seoul (KR); Sung-Ho Choi, Suwon-si (KR); Kyeong-In Jeong, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/378,236

(22) Filed: Mar. 20, 2006

(30) Foreign Application Priority Data
Mar. 18, 2005 (KR) 2005-22614

(51) Int. Cl. H04Q 7/20

(52) U.S. Cl. 455/445

(57) ABSTRACT

A method and apparatus for transmitting User Equipment (UE) capability information required for provisioning of a service to a network before a UE requests the service are provided. Before an outgoing or incoming call setup is requested for the UE, a signaling connection is established between the UE and a core network (CN) node to which the UE belongs. After the signaling connection is established, a message including UE capability information of the UE is received and stored for use when the call setup is requested.

### CROSS-REFERENCE TO RELATED APPLICATION

This application claims the benefit under 35 U.S.C. § 119(a) of a Korean patent application entitled “Method and Apparatus for Acquiring UE Capability Information in a Communication Network”, filed in the Korean Intellectual Property Office on Mar. 18, 2005 and assigned Serial No. 2005-22614, the entire contents of which are hereby incorporated by reference.

### BACKGROUND OF THE INVENTION

1. Field of the Invention

The present invention relates generally to a communication system. In particular, the present invention relates to a method and apparatus for transmitting information about the capabilities of a User Equipment (UE) to a network before a call setup in the UE.

2. Description of the Related Art

In a conventional call setup procedure, a UE transmits information about the UE capabilities in relation to call data processing to a network during requesting a call setup. The UE capability information comprises the phone number and supported CODEC list of the UE. The capability information of the calling UE is transferred to and stored in a called network node. The called network node then forwards the call setup request from the calling UE to a called UE. The called UE transmits its capability information to the called network node, such as Mobile Switching Center (MSC), by a response message. The called network node, which has acquired the UE capability information from both the calling UE and the called UE, forwards corresponding information to the calling UE based on the UE capability information, thereby establishing a bearer.

FIG. 1 is a diagram illustrating a signal flow for a conventional call setup procedure. UE capability information provides supported CODECs herein, by way of example. The conventional call setup procedure will be described in the context of Tandem Free Operation (TFO) or Transcoding Free Operation (TrFO), a technique that obviates the need for additional CODEC translation during a call by finishing negotiations on CODECs during establishing a bearer for the call. CODEC information used to deliver voice information during a TrFO-supporting Circuit Switched (CS) call setup is determined at a CS connection setup.

Referring to FIG. 1, a calling UE 101 (UE-1) transmits a SETUP message to a Core Network (CN) 103 (CN-1) via a Radio Network Controller (RNC) 102 (RNC-1) in order to request a call setup in step 107. The SETUP message comprises a supported CODEC list of UE-1 which lists CODEC indexes x, y, z and w.

In step 108, CN-1 stores the supported CODEC list and transmits a CALL PROCEEDING message to UE-1. CN-1 then translates the SETUP message to an Initial Address Message (IAM) message by the System Signaling No. 7 (SS7) ISDN User Part (ISUP) protocol and transmits the supported CODEC list by the IAM message to a CN 104 (CN-2) to which a called UE 106 (UE-2) belongs in step 110.

CN-2 stores the supported CODEC list of UE-1. To place UE-2 to a connected mode, CN-2 pages UE-2, sets up a Radio Resource Control (RRC) connection with UE-2, and receives a response for the paging from UE-2 in step 112.

In step 114, CN-2 translates the IAM message received from CN-1 to the SETUP message and forwards it as a call setup request from UE-1 to UE-2. UE-2 transmits a CALL CONFIRMED message containing its supported CODEC list with y, z, w and v to CN-2 via an RNC 105 (RNC-2) in step 115. CN-2 selects a CODEC to be used from the supported CODEC lists of UE-1 and UE-2 and transmits a Bearer Information message comprising the selected CODEC and an Available CODEC List to CN-1 in step 117. The selected CODEC is y and the available CODEC list has y, z and w, for example.

In step 119, CN- 1 establishes a data bearer with CN-2 based on the Bearer Information message. After the bearer setup, a Radio Access Bearer (RAB)/Radio Bearer (RB) for the caller is established between UE-1 and CN-1 in step 121. CN-1 then notifies CN-2 of completion of the RAB/RB setup by a Continuity message in step 123.

In step 125, an RAB/RB for the called is established between UE-2 and CN-2. After the RAB/RB setup, UE-2 transmits to CN-2 an Alerting message as ringing information indicating that it is prepared for a call setup in step 127. CN-2 translates the Alerting message to an ISUP Address Complete Message (ACM) message and transmits the ISUP ACM message to CN-1 in step 129. CN-1 recovers the ACM message to the Alerting message and transmits the Alerting message to UE-1 in step 131.

In step 133, as the called lifts his receiver (Hook-Off) and thus a call starts, UE-2 transmits a Connect message to CN-2. CN-2 translates the Connect message to an ISUP Answer Message (ANM) message and transmits the ISUP ANM message to CN-1 in step 135. In step 138, CN-1 recovers the ANM message to the Connect message indicating the call connection and forwards the Connect message to UE-1. In steps 134 and 139, CN-1 and CN-2 transmit Connect Ack messages to UE-1 and UE-2, respectively. Thus, the call setup is completed.

As described above, UE capability information related to UEs and a service is exchanged between CNs during a call service request from a calling UE and a bearer setup for the call service. This capability information exchange triggers capability negotiation, and an end-to-end bearer, that is, a bearer for the call between the caller and the called is established based on the capability negotiation. Therefore, the end-to-end call setup leads to degraded service quality and an increased latency due to additional time delay.

### SUMMARY OF THE INVENTION

An object of the present invention is to substantially solve at least the above problems and/or disadvantages and to provide at least the advantages below. Accordingly, the present invention provides a method and apparatus for reducing an overall latency in providing a fast end-to-end call service to a user.

Exemplary implementation of the present invention provides a method and apparatus for transmitting UE capability information required for provisioning of a user-requested service to a network before the service request in order to provide the service fast to a user.

According to one aspect of the present invention, a method of acquiring UE capability information in a communication network is provided. Before an outgoing or incoming call setup is requested for a User Equipment (UE), a signaling connection is established between the UE and a Core Network (CN) node to which the UE belongs. After the signaling connection is established, a message comprising UE capability information of the UE is received and stored in the CN node for use when the call setup is requested.

According to another aspect of the present invention, a UE apparatus for transmitting UE capability information to a network in a communication network is provided. A message transmitter transmits a message comprising UE capability information of a UE through a signaling connection established between the UE and a CN node to which the UE belongs, before an outgoing or incoming call setup is requested for the UE. A message receiver receives a response message indicating whether the UE capability information has been stored from the CN node. A call processor determines whether to include the UE capability information in a confirmed message in response to a setup message or a call setup request message for requesting a call setup according to whether the UE capability information has been stored in the CN node.

According to a further aspect of the present invention, an apparatus for acquiring UE capability information in a communication network is provided. A message transmitter and receiver establish a signaling connection with a UE and receive a message comprising UE capability information of the UE, before an outgoing or incoming call setup is requested for the UE. A UE capability information storage stores the UE capability information for use when the call setup is requested. A call processor acquires the UE capability information from the message and stores the UE capability information in the UE capability information storage.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating a signal flow for a conventional call setup procedure;

FIG. 2 is a diagram illustrating a signal flow for a call setup procedure according to a first exemplary embodiment of the present invention;

FIG. 3 is a diagram illustrating a signal flow for a call setup procedure according to a second exemplary embodiment of the present invention;

FIG. 4 is a diagram illustrating a signal flow for a call setup procedure according to a third exemplary embodiment of the present invention;

FIG. 5 is a block diagram of a User Equipment (UE) according to a preferred exemplary embodiment of the present invention; and

FIG. 6 is a block diagram of a Core Network (CN) according to a preferred exemplary embodiment of the present invention.

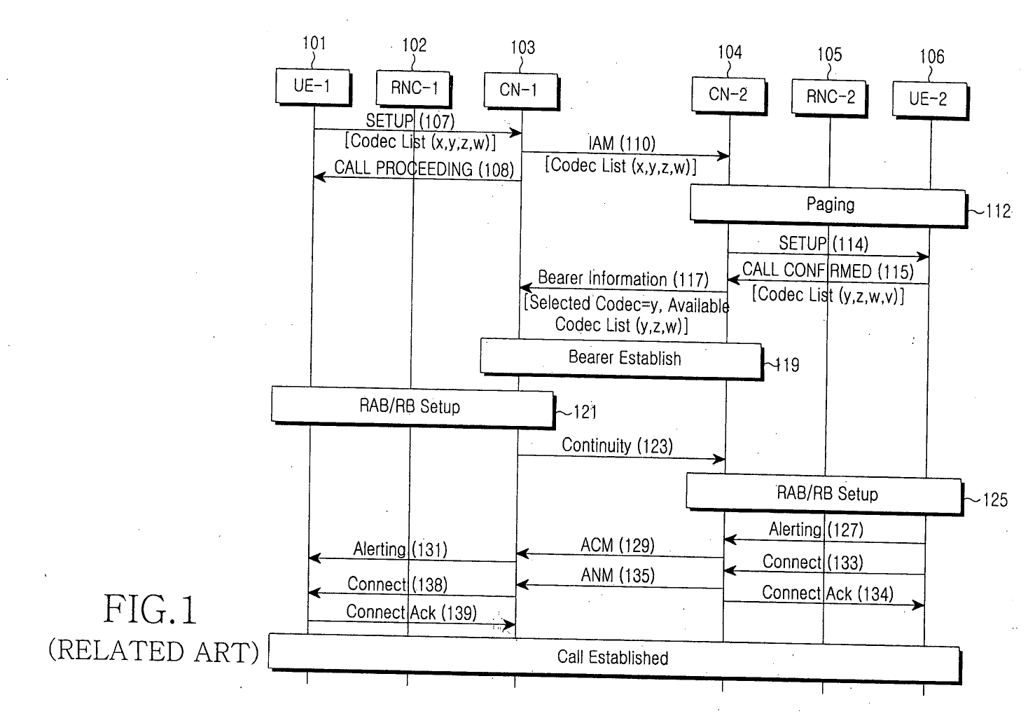

Throughout the drawings, like reference numerals will be understood to refer to like parts, components and structures.

### DETAILED DESCRIPTION OF EXEMPLARY EMBODIMENTS

Exemplary embodiments of the present invention will be described in greater details herein below with reference to the accompanying drawings. In the following description, well-known functions or constructions will be omitted for clarity and conciseness.

The subject matter of the present invention is to transmit User Equipment (UE) capability information required for providing a user-requested service to a network before the service request in order to provide the service fast to a user.

The UE capability information is transmitted to the network during the UE's attaching to the network in an exemplary embodiment of the present invention. In an exemplary embodiment, the UE capability information transmitted to a Home Location Register (HLR) during registration is acquired from the HLR. After registration and attachment, the UE capability information is transmitted to the network by a new defined message in an exemplary embodiment of the present invention.

For better understanding of an exemplary embodiment of the present invention, a UE-requested service is assumed to be a Tandem Free Operation (TFO) or Transcoding Free Operation (TrFO)-based end-to-end call service, and the UE capability information is described as CODEC information for a call service, that is, the UE's supported CODEC list. While detailed procedures, their names, and the definition of UE capability information may vary depending on the type of a service that a UE receives, the concepts are the same on the whole. The UE capability information can be the types of services available to the UE according to a network the UE has subscribed or is connected to, the UE's radio related information, identity information, charging information, authentication information, the phone number of the UE, a supported CODEC list, etc. While the present invention will be described below in the context of detailed message formats and signaling procedures used for a (CS) call, the subject matter of the present invention is not limited to the specific message names and signaling procedures.

Embodiment 1

The supported CODEC lists of UE-1 and UE-2 are transmitted to and stored in their corresponding Core Networks (CNs) during a Location Update procedure, i.e. an International Mobile System Identifier (IMSI) Attach procedure. The supported CODEC lists indicate CODEC types or CODEC modes.

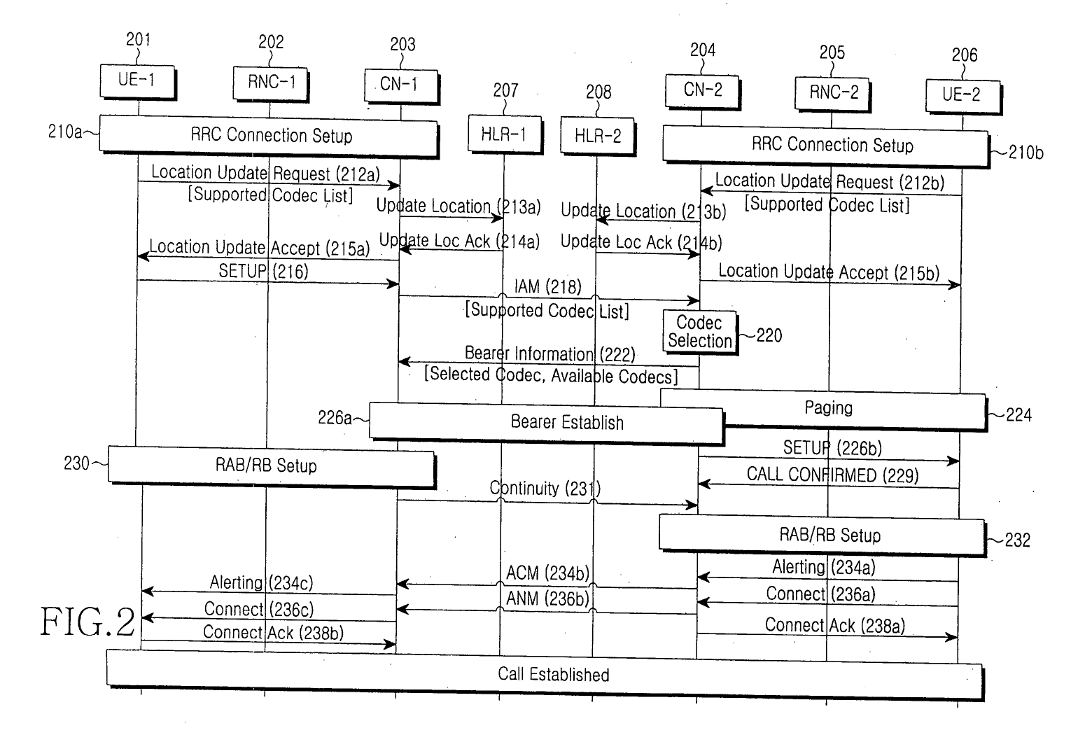

FIG. 2 is a diagram illustrating a signal flow for a call setup procedure according to an exemplary embodiment of the present invention. A calling UE 201 (UE-1) is attached to a calling CN 203 (CN-1) via a calling RNC 202 (RNC-1), and a called UE 206 (UE-2) is attached to a called CN 204 (CN-2) via a called RNC 205 (RNC-2). An HLR 207 (HLR-1) and an HLR 208 (HLR-2) to which CN-1 and CN-2 are respectively connected are the same entity or different entities.

Referring to FIG. 2, UE-1 and UE-2 establish RRC connections for signaling in steps 210a and 210b and transmit Location Update Request messages to CN-1 and CN-2, respectively in steps 212a and 212b. Each of the Location Update Request messages comprises the supported CODEC list of UE-1 or UE-2. The supported CODEC list comprises CODEC indexes supported by the UE and is stored in the CN of the UE, for later use in selecting a CODEC.

Upon receipt of the Location Update Request messages, CN-1 and CN-2 register the locations of UE-1 and UE-2 to HLR-1 and HLR-2, respectively by Update Location messages in steps 213a and 213b and receive Update Location Ack messages from HLR-1 and HLR-2 in steps 214a and 214b. After the location registration, CN-1 and CN-2 transmit Location Update Accept messages to UE-1 and UE-2, respectively in steps 215a and 215b.

To set up a call connection at a desired time point, UE-1 transmits a SETUP message to CN-1 in step 216. While the SETUP message may not have the supported CODEC list of UE-1, it can comprise the supported CODEC list, considering ‘Backward Compatibility’.

In step 218, CN-1 translates the SETUP message to an IAM message by the SS7 ISUP protocol and transmits the IAM message to CN-2. The IAM message contains the supported CODEC list of UE-1 that CN-1 received and stored in step 212a. In step 220, CN-2 selects a CODEC from the supported CODEC list of UE-1 and the stored supported CODEC list of UE-2. CN-2 then transmits a Bearer Information message comprising the selected CODEC and an Available CODEC List to CN-1 in step 222.

After paging UE-2 in step 224, CN-2 establishes a bearer with CN-1 based on the selected CODEC and the Available CODEC List in step 226a. When UE-2 responds to the paging, CN-2 forwards the SETUP message to UE-2 in step 226b and receives a CALL CONFIRMED message from UE-2 in step 229. The CALL CONFIRM message may or may not comprise the supported CODEC list of UE 2.

As done in step 220, CN-2 can select a CODEC to be used between UE-1 and UE-2 before steps 224 through 229. The selected CODEC and the Available CODEC List is transferred backward, that is, to CN-1 by the Bearer Information message, thereby supporting fast setup of a data bearer required for transmitting a call.

In step 230, an RAB/RB for the caller is established between UE-1 and CN-1 based on the selected CODEC and the Available CODEC List. CN-1 then notifies CN-2 of completion of the RAB/RB setup by a Continuity message in step 231.

In step 232, an RAB/RB for the called is established between UE-2 and CN-2 based on the selected CODEC and the Available CODEC List. After the RAB/RB setup, UE-2 transmits to CN-2 an Alerting message as ringing information indicating that it is prepared for a call setup in step 234a. CN-2 translates the Alerting message to an ISUP ACM message and transmits the ISUP ACM message to CN-1 in step 234b. CN-1 recovers the ACM message to the Alerting message and transmits the Alerting message to UE-1 in step 234c.

In step 236a, as the called lifts his receiver (Hook-Off) and thus the call starts, UE-2 transmits a Connect message to CN-2. CN-2 translates the Connect message to an ISUP ANM message and transmits the ISUP ANM message to CN-1 in step 236b. In step 236c, CN-1 recovers the ANM message to the Connect message indicating the call connection and forwards the Connect message to UE-1. In steps 238a and 238b, CN-1 and CN-2 transmit Connect Ack messages to UE-1 and UE-2, respectively. Thus, the call setup is completed.

Embodiment 2

A calling CN and a called CN acquire the CODEC information of UEs from their subscriber information stored in HLRs during registration. Upon receipt a Location Update Request message from a UE within its coverage, a CN registers the location of the UE to an HLR and the HLR forwards the subscriber information of the UE to the CN. The subscriber information comprises a supported CODEC list as UE capability information registered to the HLR during subscription. During a Location Update procedure, the HLR transmits the supported CODC list along with the subscriber information of the UE to the CN, for use in a later CODEC negotiation.

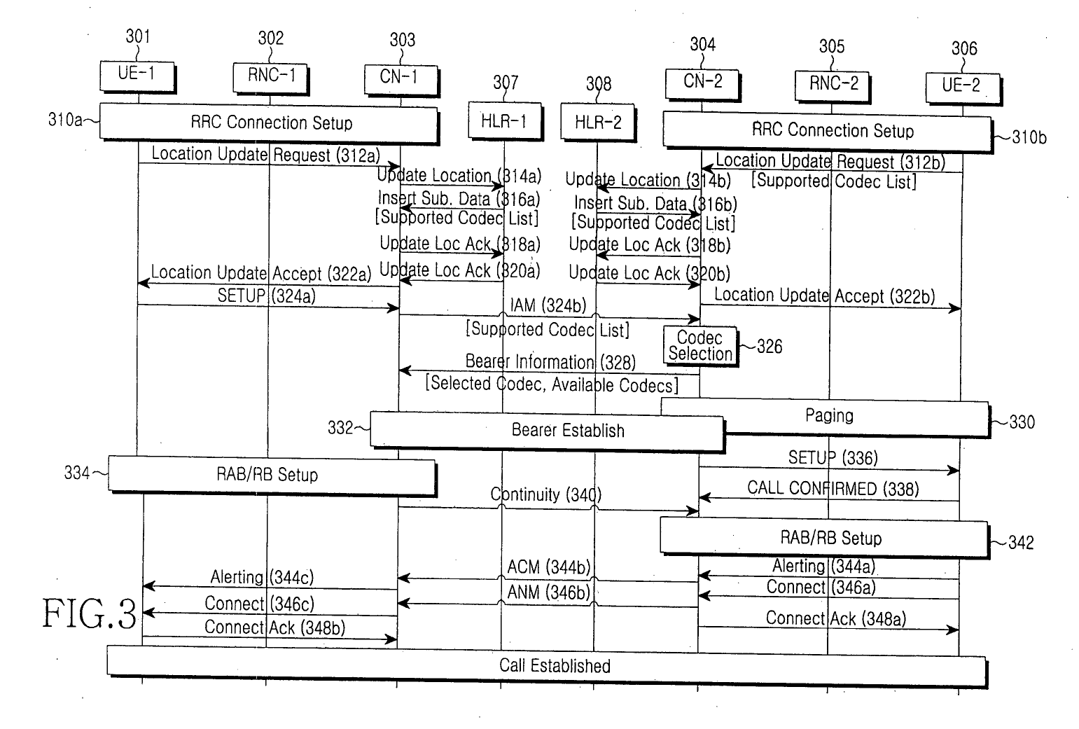

FIG. 3 is a diagram illustrating a signal flow for a call setup procedure according to an exemplary embodiment of the present invention. An HLR transmits the supported CODEC list of a UE together with the subscriber information of the UE. A calling UE 301 (UE-1) is attached to a calling CN 303 (CN-1) via a calling RNC 302 (RNC-1), and a called UE 306 (UE-2) is attached to a called CN 304 (CN-2) via a called RNC 305 (RNC-2). An HLR 307 (HLR-1) and an HLR 308 (HLR-2) to which CN-1 and CN-2 are respectively connected are the same entity or different entities.

Referring to FIG. 3, UE-1 and UE-2 establish RRC connections in steps 310a and 31b and transmit Location Update Request messages to CN-1 and CN-2, respectively in steps 312a and 312b. Each of the Location Update Request messages does not comprise the supported CODEC list of UE-1 or UE-2.

Upon receipt of the Location Update Request messages, CN-1 and CN-2 transmit Update Location messages to HLR-1 and HLR-2 in order to update the location information of UE-1 and UE-2 stored in HLR-1 and HLR-2, respectively in steps 314a and 314b. After registering the location information of UE-1 and UE-2 in the Mobility Management (MM) contexts of UE-1 and UE-2, HLR-1 and HLR-2 transmit the subscriber information and supported CODEC lists of UE-1 and UE-2 to CN-1 and CN-2, respectively in steps 316a and 316b.

After storing the subscriber information and the supported CODEC lists, CN-1 and CN-2 transmit Location Update Ack messages to HLR-1 and HLR-2, respectively, to notify successful reception of the subscriber information and the supported CODEC lists, in steps 318a and 318b. Upon receipt of Update Location Ack messages from HLR-1 and HLR-2 in steps 320a and 320b, CN-1 and CN-2 transmit Location Update Accept messages to UE-1 and UE-2, respectively in steps 322a and 322b.

Because the supported CODEC lists of UE-1 and UE-2 are delivered to CN-1 and CN-2 before transmitting and receiving the call setup request in steps 312 through 320, UE-1 and UE-2 do not need to transmit their supported CODEC lists later by a SETUP message and a CALL CONFIRMED message.

When a user intends to set up a call connection, CN-1 receives the SETUP message from UE-1, translates the SETUP message to an IAM message, and transmits the IAM message to CN-2 in steps 324a and 324b. The SETUP message may or may not contain the supported CODEC list of UE-1, for ‘Backward Compatibility’. The IAM message comprises the supported CODEC list of UE-1 that CN-1 received and stored in step 316a. In step 326, CN-2 selects a CODEC from the supported CODEC list of UE-1 acquired by the IAM message and the stored supported CODEC list of UE-2. CN-2 then transmits a Bearer Information message comprising the selected CODEC and an Available CODEC List to CN-1 in step 328.

As described above, since CN-2 preliminarily stores the subscriber information and supported CODEC list of UE-2 before UE-1 requests the call setup to UE-2, it can select a CODEC without awaiting receipt of the CALL CONFIRMED message from UE-2.

After paging UE-2 in step 330, CN-2 establishes a bearer with CN-1 based on the selected CODEC and the Available CODEC List in step 332. When UE-2 responds to the paging, CN-2 forwards the SETUP message to UE-2 in step 336 and receives the CALL CONFIRMED message from UE-2 in step 338. The CALL CONFIRM message may comprise the supported CODEC list of UE 2, for ‘Backward Compatibility, or may not.

In step 334, an RAB/RB for the caller is established between UE-1 and CN-1 based on the selected CODEC and the Available CODEC List. CN-1 then notifies CN-2 of completion of the RAB/RB setup by a Continuity message in step 340.

In step 342, an RAB/RB for the called is established between UE-2 and CN-2 based on the selected CODEC and the Available CODEC List. After the RAB/RB setup, UE-2 transmits to CN-2 an Alerting message as ringing information indicating that it is prepared for a call setup in step 344a. CN-2 translates the Alerting message to an ISUP ACM message and transmits the ISUP ACM message to CN-1 in step 344b. CN-1 recovers the ACM message to the Alerting message and transmits the Alerting message to UE-1 in step 344c.

In step 346a, when the called lifts his receiver (Hook-Off) and thus the call starts, UE-2 transmits a Connect message to CN-2. CN-2 translates the Connect message to an ISUP ANM message and transmits the ISUP ANM message to CN-1 in step 346b. In step 346c, CN-1 recovers the ANM message to the Connect message indicating the call connection and forwards the Connect message to UE-1. In steps 348a and 348b, CN-1 and CN-2 transmit Connect Ack messages to UE-1 and UE-2, respectively. Thus, the call setup is completed.

In accordance with the second exemplary embodiment of the present invention, the time delay of selecting a CODEC can be reduced by as much as the processing time of establishment of the RRC connection between UE-2 and RNC-2 by paging UE-2 by CN-2, transmission of the SETUP message, and acquisition of the supported CODEC list from UE-2 by the CALL CONFIRMED message.

Embodiment 3

A UE transmits its supported CODEC list to the CN to which it belongs by a new defined message. This message is called a ‘Capability Information’ message in the present invention. The Capability Information message comprises information about all CODECs supported by the UE. The Capability Information message can notify of the supported CODEC, i.e. UE capability information at any time before the UE requests a call as well as during a Location Update procedure.

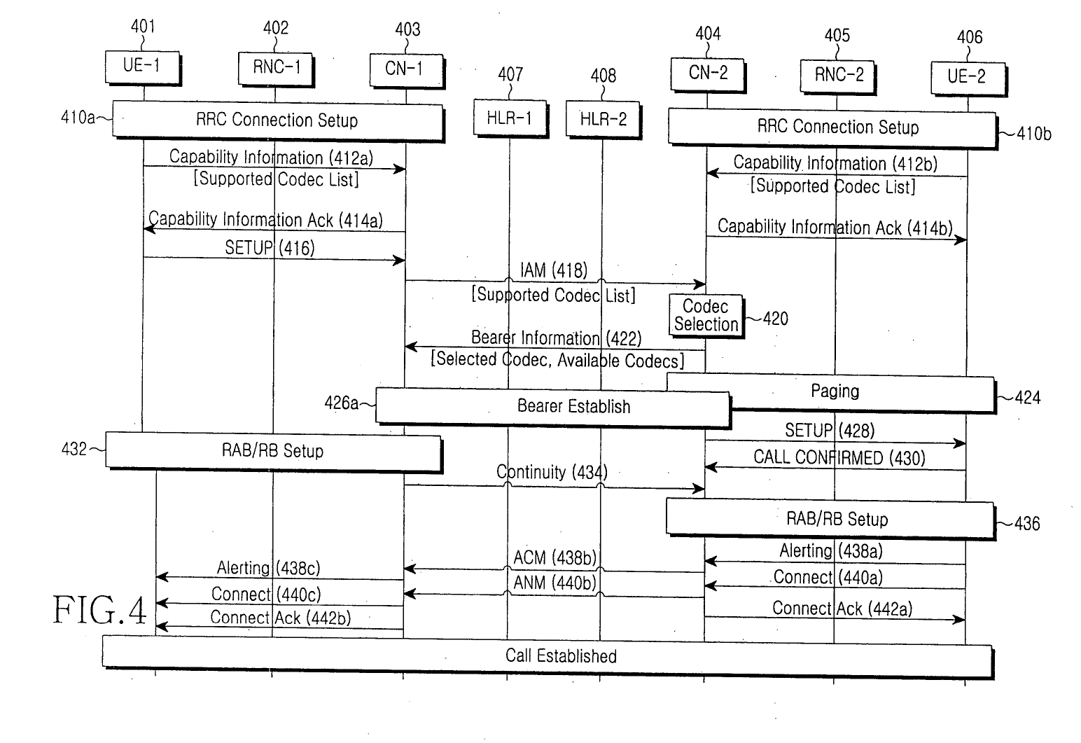

FIG. 4 is a diagram illustrating a signal flow for a call setup procedure according to a third exemplary embodiment of the present invention. A calling UE 401 (UE-1) is attached to a calling CN 403 (CN-1) via a calling RNC 402 (RNC-1), and a called UE 406 (UE-2) is attached to a called CN 404 (CN-2) via a called RNC 405 (RNC-2). An HLR 407 (HLR-1) and an HLR 408 (HLR-2) to which CN-1 and CN-2 are respectively connected are the same entity or different entities.

Referring to FIG. 4, UE-1 and UE-2 establish RRC connections in steps 410a and 410b and transmit their supported CODEC lists to CN-1 and CN-2, respectively by Capability Information messages at a particular time point before a call setup in steps 412a and 412b. CN-1 and CN-2 acquire and store the supported CODEC lists from the Capability Information messages and transmit Capability Information Ack messages to UE-1 and UE-2, respectively in steps 414a and 414b. While not shown, in the case where CN-1 and CN-2 cannot process the supported CODEC lists, they transmit Error messages instead of the Capability Information Ack messages.

In step 412a through step 414b, CN-1 and CN-2 acquire the supported CODEC lists of UE-1 and UE-2 by receiving the Capability Information messages and the Capability Information Ack messages and UE-1 and UE-2 perform the call setup by receiving the Capability Information Ack messages.

When the user intends to set up a call connection, UE-1 transmits a SETUP message to CN-1, for the call setup in step 416. If UE-1 and UE-2 confirm by the Capability Information Ack messages that CN-1 and CN-2 have stored the supported CODEC lists in steps 414a and 414b, the SETUP message may not comprise the supported CODEC list of UE-1.

In step 418, CN-1 translates the SETUP message to an IAM message and transmits the IAM message with the supported CODEC list of UE-1 to CN-2.

CN-2 selects a CODEC from the supported CODEC list of UE-1 acquired by the IAM message and the stored supported CODEC list of UE-2 in step 420 and then transmits a Bearer Information message comprising the selected CODEC and an Available CODEC List to CN-1 in step 422.

While not shown, if CN-2 does not have the supported CODEC list of UE-2 by the time when receiving the IAM message, CN-2 pages UE-2, establishes an RRC connection, and acquires the supported CODEC list of UE-2 by exchanging a SETUP message and a CALL CONFIRMED message, as done conventionally.

After paging UE-2 in step 424, CN-2 establishes a bearer with CN-1 based on the selected CODEC and the Available CODEC List in step 426a. When UE-2 responds to the paging, CN-2 forwards the SETUP message to UE-2 in step 428 and receives the CALL CONFIRMED message from UE-2 in step 430.

Since CN-1 and CN-2 have already stored the supported CODEC lists of UE-1 and UE-2 by the CODEC Information messages and CODEC Information Ack messages, the CALL CONFIRMED message may not comprise the supported CODEC list of UE-2 but may comprise it for ‘Backward Compatibility’.

In step 432, an RAB/RB for the caller is established between UE-1 and CN-1 based on the selected CODEC and the Available CODEC List. CN-1 then notifies CN-2 of completion of the RAB/RB setup by a Continuity message in step 434.

In step 436, an RAB/RB for the called is established between UE-2 and CN-2 based on the selected CODEC and the Available CODEC List. After the RAB/RB setup, UE-2 transmits to CN-2 an Alerting message as ringing information indicating that it is prepared for a call setup in step 438a. CN-2 translates the Alerting message to an ISUP ACM message and transmits the ISUP ACM message to CN-1 in step 438b. CN-1 recovers the ACM message to the Alerting message and transmits the Alerting message to UE- 1 in step 438c.

In step 440a, when the called lifts his receiver (Hook-Off) and thus the call starts, UE-2 transmits a Connect message to CN-2. CN-2 translates the Connect message to an ISUP ANM message and transmits the ISUP ANM message to CN-1 in step 440b. In step 440c, CN-1 recovers the ANM message to the Connect message indicating the call connection and forwards the Connect message to UE-1. In steps 442a and 442b, CN-1 and CN-2 transmit Connect Ack messages to UE-1 and UE-2, respectively. Thus, the call setup is completed.

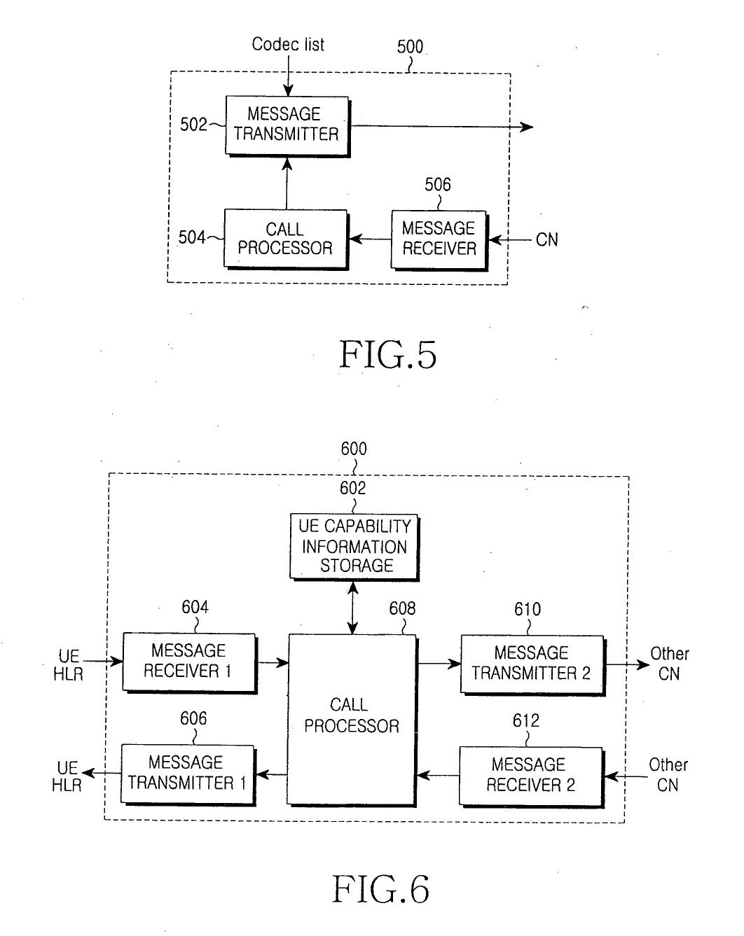

With reference to FIGS. 5 and 6, the configurations of a UE and a CN for implementing the above exemplary embodiments of the present invention will be described below.

FIG. 5 is a block diagram of a UE according to a preferred exemplary embodiment of the present invention. Referring to FIG. 5, a UE 500 comprises a message transmitter 502, a call processor 504, and a message receiver 506.

The message transmitter 502 generates a message comprising UE capability information such as a supported CODEC list and transmits the message to a CN that the UE 500 belongs to. The message is a Location Update Request message or a Capability Information message according to one of the first, second and third exemplary embodiments. The message transmitter 502 also transmits messages for a call setup with the other party and transmits the messages to the CN via an RNC, under the control of the call processor 504. After the call setup, the message transmitter 502 transmits call data.

The message receiver 506 receives a response message indicating whether the UE capability information has been stored from the CN to which the UE 500 belongs, and transmits the response message to the call processor 504. The message receiver 506 also receives message for the call setup with the other party, interprets the received messages, and receives call data after the call setup, under the control of the call processor 504.

The call processor 504 establishes a radio bearer for a call service with the other party by controlling the message transmitter 502 and the message receiver 506. Particularly, the call processor 504 controls the message transmitter 502 to transmit the UE capability information before the call setup, receives the response message indicating whether the UE capability information has been stored in a corresponding CN through the message receiver 506, and determines whether to comprise the UE capability information in a SETUP message or a CALL CONFIRM message generated from the message transmitter 502 according to the response message. If the UE capability information has already been stored in the CN, the SETUP message or the CALL CONFIRM message may not comprise the UE capability information.

FIG. 6 is a block diagram of a CN according to a preferred exemplary embodiment of the present invention.

Referring to FIG. 6, a CN 600 comprises a message receiver 604 (message receiver 1) and a message transmitter 606 (message transmitter 1) for transmitting/receiving messages to/from a UE within its coverage and an HLR, a message transmitter 610 (message transmitter 1) and a message receiver 612 (message receiver 2) for transmitting/receiving messages to/from another CN, a UE capability information storage 602, and a call processor 608.

The message receivers 604 and 612 receive a message comprising UE capability information from a UE irrespective of whether the UE within the coverage of the CN 600 is a caller or a called and provide the received message to the call processor 608. The message is a Location Update Request message or a Capability Information message according to one of the first, second and third exemplary embodiments. The UE capability information storage 602 stores the UE capability information acquired through the message receivers 604 and 612 by the call processor 608.

In the case where the UE is a caller, the message receiver 604 provides a SETUP message for requesting a call service received from the UE to the call processor 608. The SETUP message may comprise the supported CODEC list of the UE, for ‘Backward Compatibility’, or may not. The call processor 608 translates the SETUP message to an IAM message, comprises the UE capability information read from the UE capability information storage 602 in the IAM message, and transmits the IAM message to a called CN through the message transmitter 610.

In response to the IAM message, the message receiver 612 receives a Bearer Information message comprising a selected CODEC and an Available CODEC list for the call service from the called CN and provides the received message to the call processor 608.

The call processor 608 acquires the selected CODEC and the Available CODEC list from the Bearer Information message. Based on the selected CODEC and the Available CODEC list, the call processor 608 establishes a radio bearer for the call service with the UE by controlling the message transmitter 606 and the message receiver 604, and establishes a data bearer with the called CN by controlling the message transmitter 610 and the message receiver 612.

In the case where the UE is a called, the message receiver 605 receives an IAM message comprising the supported CODEC list of a calling UE from a calling CN and provides the IAM message to the call processor 608. The call processor 608 reads the supported CODEC list of the UE from the UE capability information storage 602 and acquires the supported CODEC list of the calling UE from the IAM message. It then selects a CODEC commonly existing in both the supported CODEC lists, for the call service, and generates an Available CODEC List. The call processor 608 transmits the selected CODEC and the Available CODEC List by a BEARER Information message to the calling CN through the message transmitter 601.

Meanwhile, the call processor 608 establishes a radio bearer for the call service with the UE by controlling the message transmitter 606 and the message receiver 604, and establishes a data bearer with the called CN by controlling the message transmitter 610 and the message receiver 612.

The UE and the CN configured as illustrated in FIGS. 5 and 6 acquire the capability information of a corresponding UE before a call setup. The resulting decrease of a latency involved in a UE capability information acquisition procedure during the call setup allows for a more efficient call service procedure.

In accordance with the present invention as described above, since a UE registers information destined for a network to a provider network or transmits the information to the network at a later specific time during requesting a particular service, the latency of the call setup can be reduced when a user wants the service.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method of acquiring User Equipment (UE) capability information in a communication network, comprising the steps of:
establishing a signaling connection between a UE and a core network (CN) node to which the UE belongs, before an outgoing or incoming call setup is requested for the UE;
receiving a message comprising UE capability information of the UE, after the signaling connection is established; and
storing the UE capability information in the CN node, for use when the call setup is requested.

2. The method of claim 1, wherein the message comprising the UE capability information is a location update request message received from the UE though the signaling connection.

3. The method of claim 1, wherein the message comprising the UE capability information is a capability information message defined to deliver the UE capability information, received from the UE through the signaling connection.

4. The method of claim 1, wherein the message comprising the UE capability information is an insert subscriber data message received from a home location register (HLR) to which the UE belongs in response to an update location message transmitted to the HLR to request a location update for the UE.

5. The method of claim 1, further comprising the step of, upon receipt of a setup message from the UE to request a call service with a UE of the other party, generating an initial address message (IAM) comprising the stored UE capability information and transmitting the IAM message to a CN node to which the UE of the other party belongs in the CN node.

6. The method of claim 5, further comprising the step of receiving a bearer information message comprising a selected coder-decoder (CODEC) and an available CODEC list from the CN node of the other party, and establishing a radio bearer with the UE and a data bearer with the CN node of the other party based on the selected CODEC and the available CODEC list, for the call service in the CN node.

7. The method of claim 1, further comprising the step of receiving an IAM message comprising UE capability information of the UE of the other party, requesting the call service from the CN node of the other party, selecting a CODEC for the call service and generating an available CODEC list based on the UE capability information of the UE of the other party and the stored UE capability information, generating a bearer information message the selected CODEC and the available CODEC list, and transmitting the bearer information message to the CN node of the other party.

8. The method of claim 7, further comprising the step of establishing a radio bearer with the UE and a data bearer with the CN node of the other party based on the selected CODEC and the available CODEC list, for the call service in the CN node.

9. The method of claim 1, wherein the UE capability information comprises at least one of the types of services available to the UE according to a network to which the UE is subscribed or connected, radio-related information about the UE, identification information, billing information, authentication information, a phone number of the UE, and a supported CODEC list of the UE.

10. An apparatus for transmitting User Equipment (UE) capability information to a network in a communication network, comprising:
a message transmitter for transmitting a message comprising UE capability information of a UE through a signaling connection established between the UE and a core network (CN) node to which the UE belongs, before an outgoing or incoming call setup is requested for the UE;
a message receiver for receiving a response message indicating whether the UE capability information has been stored from the CN node; and
a call processor for determining whether to comprise the UE capability information in a confirmed message in response to a setup message or a call setup request message for requesting a call setup according to whether the UE capability information has been stored in the CN node.

11. The apparatus of claim 10, wherein the message comprising the UE capability information is a location update request message for the UE.

12. The apparatus of claim 10, wherein the message comprising the UE capability information is a capability information message defined to deliver the UE capability information.

13. The apparatus of claim 10, wherein the UE capability information comprises at least one of the types of services available to the UE according to a network to which the UE is subscribed or connected, radio-related information about the UE, identification information, billing information, authentication information, a phone number of the UE, and a supported CODEC list of the UE.

14. An apparatus for acquiring User Equipment (UE) capability information in a communication network, comprising:
a message transmitter and receiver for establishing a signaling connection with a UE and receiving a message comprising UE capability information of the UE, before an outgoing or incoming call setup is requested for the UE;
a UE capability information storage for storing the UE capability information for use when the call setup is requested; and
a call processor for acquiring the UE capability information from the message and storing the UE capability information in the UE capability information storage.

15. The apparatus of claim 14, wherein the message comprising the UE capability information is a location update request message received from the UE though the signaling connection.

16. The apparatus of claim 14, wherein the message comprising the UE capability information is a capability information message defined to deliver the UE capability information, received from the UE through the signaling connection.

17. The apparatus of claim 14, wherein the message comprising the UE capability information is an insert subscriber data message received from a home location register (HLR) to which the UE belongs in response to an update location message transmitted to the HLR to request a location update for the UE.

18. The apparatus of claim 14, wherein upon receipt of a setup message from the UE through the message transmitter and receiver to request a call service with a UE of the other party, the call processor generates an initial address message (IAM) comprising the stored UE capability information and transmits the IAM message to a CN node to which the UE of the other party belongs.

19. The apparatus of claim 18, wherein upon receipt of a bearer information message comprising a selected coder-decoder (CODEC) and an available CODEC list through the message transmitter and receiver, the call processor establishes a radio bearer with the UE and a data bearer with the CN node of the other party based on the selected CODEC and the available CODEC list, for the call service.

20. The apparatus of claim 14, wherein the call processor receives an IAM message comprising UE capability information of the UE of the other party, requesting the call service from the CN node of the other party through the message transmitter and receiver, selects a CODEC for the call service and generating an available CODEC list based on the UE capability information of the UE of the other party and the stored UE capability information, generates a bearer information message the selected CODEC and the available CODEC list, and transmits the bearer information message to the CN node of the other party.

21. The apparatus of claim 20, wherein the call process establishes a radio bearer with the UE and a data bearer with the CN node of the other party based on the selected CODEC and the available CODEC list, for the call service.

22. The apparatus of claim 14, wherein the UE capability information comprises at least one of the types of services available to the UE according to a network to which the UE is subscribed or connected, radio-related information about the UE, identification information, billing information, authentication information, a phone number of the UE, and a supported CODEC list of the UE.
